(19) United States
(12) Patent Application Publication
(10) Pub. No.: US 2002/0059572 A1
(43) Pub. Date: May 16, 2002

(54) Network, transmitter terminal and method of forming an access point in a data stream

(76) Inventor: Laurent Duquesnois, Limeil-Brevannes (FR)

Correspondence Address: U.S. Philips Corporation, 580 White Plains Road, Tarrytown, NY, 10591, US

(21) Appl. No.: 09/821,129

(22) Filed: Mar. 29, 2001

(30) Foreign Application Priority Data
Apr. 4, 2000 (FR) 0004288

(51) Int. Cl. H04N 7/16

(52) U.S. Cl. 725/1

(57) ABSTRACT

The invention relates to the domain of multi-media scene description. In a conventional manner a scene description stream comprises coded data relating to scene descriptions and coded data relating to scene modifications. Access points to the stream are provided to permit a user to get into the stream at whatever instant. These access points are formed by data relating to a complete scene description. In accordance with the invention, when a scene description is coded, the coded data resulting therefrom are stored in a memory. And access points inserted into the stream are formed by the coded data stored in this memory. One thus avoids to code a new scene description every time an access point is to be inserted into the stream.

### FIELD OF THE INVENTION

The invention relates to a telecommunications network comprising at least:

a transmitter terminal including a multi-media scene description coder for producing a data stream which contains access points formed by coded data relating to a complete scene description,

and a receiver terminal which may be connected at any instant to said transmitter terminal for receiving said data stream.

The invention also relates to:

a terminal including a multi-media scene description coder for delivering a data stream which includes access points formed by coded data relating to a complete scene description;

a method of forming an access point in a data stream, said access points being formed by coded data relating to a complete scene description;

and a signal conveying a data stream that comprises access points formed by coded data relating to a complete scene description.

The invention has highly significant applications in the field of multi-user transmissions of multi-media data. The invention is applicable, for example, to the post-production of television broadcasts, or to the superpositioning of multi-media scenes on a traditional digital video, for example, for advertising.

### BACKGROUND OF THE INVENTION

The MPEG-4 standard is notably described in the document ISO/IEC 14496-1 entitled “Information Technology—Very Low Bit Rate Audio-Visual Coding—part 1: systems” published by the ISO 1999.

This standard describes individual coding means for audio, visual or audio-visual objects, and means for composing multi-media scenes based on such objects. The data necessary for the composition of a scene constitute the description of the scene.

This scene description concept is discussed in paragraph 9 of the MPEG-4 standard. Summarizing, in the MPEG-4 standard the scene descriptions have a tree structure. Each node of the structure corresponds to an object and contains a set of parameters, notably parameters for positioning the object in time and space. Such a tree structure is not static: the parameters of the nodes may be modified, nodes may be added, replaced or suppressed. The MPEG-4 standard defines two types of commands relating to the scene descriptions: on the one hand, a command for scene replacement, which contains a description of the entire scene, and on the other hand, commands to modify the scene, which contain modifications to be made in a scene description. These scene replacement and modification commands form part of a data stream currently called BIFS stream (BInary Format for Scene). The scene replacement commands form the only access points to this stream, that is to say, the only points via which a user can get into this stream. The invention relates to the formation of an access point in a data stream, which data relate to multi-media scene descriptions.

### SUMMARY OF THE INVENTION

A telecommunications network in accordance with the invention and as described in the opening paragraph is characterized in that said transmitter terminal includes a storage memory for storing data coded at a given instant which relate to a description of a complete scene, the stored data being intended to be used at one or several later instants to form said access points.

A terminal in accordance with the invention and as described in the opening paragraph is characterized in that it includes a storage memory for storing data coded at a given instant and relating to a complete scene description, the stored data being intended to be used at one or several later instants to form said access points.

A method in accordance with the invention and as described in the opening paragraph, of forming an access point in a data stream is characterized in that it comprises a step of storing data coded at a given instant and relating to a complete scene description, the stored data being intended to be used at one or several later instants to form said access points.

Finally, a signal in accordance with the invention and as described in the opening paragraph is characterized in that at least various successive access points are formed by the same complete scene description.

In accordance with the invention, coded data relating to the description of a complete scene are thus stored, and these coded data are then re-used to form the following access points in the data stream. In this manner it is avoided that one has to recode a scene each time one wishes to transmit an access point.

In a preferred embodiment of the invention the access points are made in the data stream in timing with a replacement clock, and the data stream comprises data relating to modifications to be made in a complete scene, which are made in the stream in timing with a modification clock, which presents a non-zero phase shift with the replacement clock.

For example, access points are transmitted every i seconds starting from an initial instant t₀ onwards, and data relating to scene modifications every j milliseconds from the instant t₁ onwards, shifted by k milliseconds relative to t₀ (with k≠j).

Thus it is ensured that the transmission instants of the access points and of the data relating to the scene modifications do not coincide.

For certain applications, more particularly when the scene to be transmitted may change quite frequently, it is advantageous to renew the complete scene description for which coded data are stored in the memory, in timing with a replacement clock. For example, the description of a complete scene is renewed every minute.

### BRIEF DESCRIPTION OF THE DRAWINGS

These and other aspects of the invention are apparent from and will be elucidated, by way of non-limitative example, with reference to the embodiment(s) described hereinafter.

In the drawings:

FIG. 1 represents an example of a network in accordance with the invention,

FIG. 2 represents a block diagram of a transmitter terminal in accordance with the invention, and

FIG. 3 is a time diagram indicating the instants at which the access points and the data relating to the scene modifications are transmitted, as well as the complete scene descriptions to which these modifications relate.

### DESCRIPTION OF A PREFERRED EMBODIMENT OF THE INVENTION

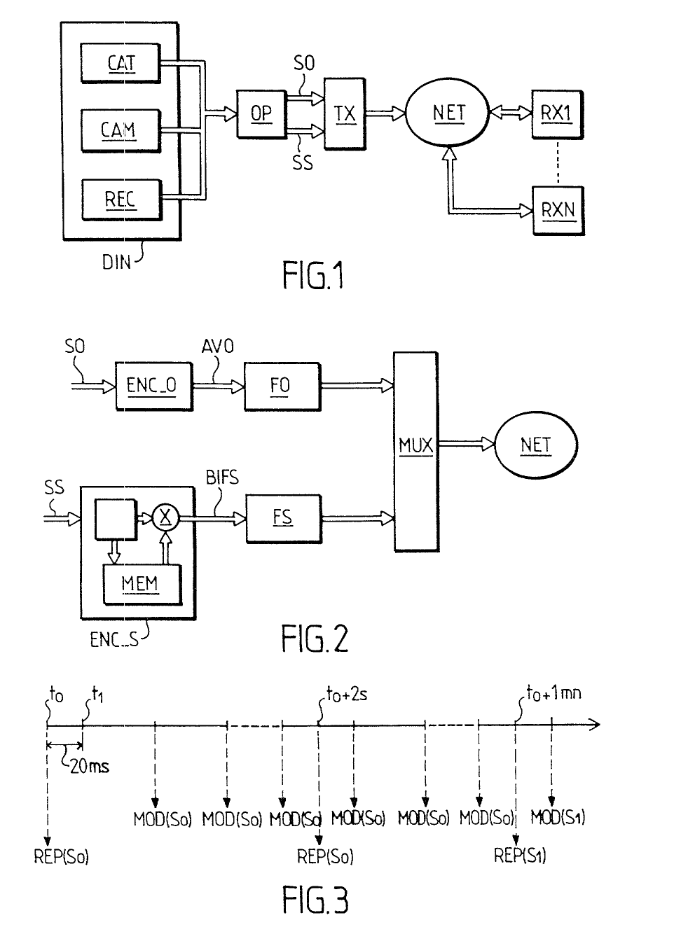

In FIG. 1 is shown an example of a network in accordance with the invention. This network comprises an audio and/or video object source, DIN, which is connected to a transmitter terminal TX via an operator station OP, a transmitter medium NET and a plurality of receiving terminals RX1, . . . , RXN. The object source DIN comprises, for example, a catalogue CAT which contains predefined objects, a camera CAM which produces video images, and a recorder REC which produces audio data. An operator installed at the operator station OP selects objects among the data produced by the source DIN, and places the selected objects in a scene. For this purpose, the video images produced by the camera CAM and the audio data produced by the recorder REC are processed as objects. The operator station OP delivers two data streams: one stream SO of audio/video objects and one stream SS of scene descriptions. These streams are transmitted to the transmitter terminal TX.

As indicated in FIG. 2, the transmitter terminal TX notably includes an audio/video object coder ENC-0 for coding the stream SO of audio/video objects, and a scene description coder ENC-S for coding the stream SS of scene descriptions. The audio/video object coder ENC-0 delivers coded data AV0, which are transmitted to a first formatting device FO. The scene description coder ENC-S delivers data in the BIFS format, notably scene descriptions DES and scene modifications MOD, which are transmitted to a second formatting device FS. The formatting device FS delivers data units AU, which notably contain BIFS control frames (scene replacement control REP or scene modification control MOD). Finally, a multiplexer MUX permits to multiplex the formatted data coming from the two formatting devices F0 and FS. The multiplexed data are transmitted via a transmission medium NET.

In practice, in order to reduce the quantity of data to be transmitted, the terminal TX starts sending a complete scene description and it then sends modifications to be applied to the scene that has been described.

The receiving terminals RX1 to RXN may be connected to the network any moment to receive the data transmitted by the transmitter terminal TX. When they are connected, they need a complete scene description to be able to understand the transmitted modifications. This complete scene description is called access point to the BIFS stream. In order to permit to the receiving terminals to be connected at any instant, the transmitter terminal TX regularly transmits a complete scene description in a scene replacement command.

In accordance with the invention the coder ENC-S comprises an actual coding block COD, a memory MEM which permits to store the coded data relating to a complete scene description, and a switch block X for connecting the input of the second formatting device FS, either to the output of the coding block COD, or to the output of the memory MEM. When the transmitter terminal codes a scene description, the coded data are stored in the memory MEM. Arid the access points to the BIFS stream are then formed with the coded data that are stored in the memory.

In an embodiment that is particularly simple to use, the transmitter terminal transmits:

commands REP to replace the scene containing a complete description of an initial scene, in timing with a replacement clock H_{REP},

and MOD commands to modify the initial scene, in timing with a modification clock H_{MOD}, which presents a non-zero phase shift with the replacement clock.

When the nature of the transmitted scenes justifies same, the complete scene description that has been used for forming access points to the BIFS stream is renewed from time to time in timing with a replacement clock H_{RNW}. This means that the transmitter terminal recodes a new complete scene description and stores the coded data resulting therefrom in the memory MEM.

FIG. 3 shows a timing diagram which indicates the various transmission instants in the case where the transmitter terminal transmits scene replacement commands REP every 2 s from an initial instant t₀ onwards, and by the scene modification commands MOD every 40 ms from the instant t₁ onwards shifted by 20 ms relative to t₀.

In the example shown the complete scene description which is used for forming the access points to the BIFS stream is renewed every minute, so that all the commands transmitted in the time interval [t₀; t₀+1 mn[ relate to the same scene description S₀, and all the commands transmitted in the time interval [t₀+1 mn; t₀+2 mn[ relate to another scene description S₁.

Preferably, the devices described in FIG. 2 are realized in the form of a dedicated processor managed by one or various computer programs.

The invention has been described within the framework of the scene description format BIFS described in the MPEG-4 standard. This is not restrictive: the invention is also applicable to other scene description formats.

1. A telecommunications network comprising at least:
a transmitter terminal including a multi-media scene description coder for producing a data stream which contains access points formed by coded data relating to a complete scene description,
and a receiver terminal which may be connected at any instant to said transmitter terminal for receiving said data stream,
characterized in that said transmitter terminal includes a storage memory for storing data coded at a given instant and relating to a description of a complete scene, the stored data being intended to be used at one or several later instants to form said access points.

2. A terminal including a multi-media scene description coder for delivering a data stream which includes access points formed by coded data relating to a complete scene description, characterized in that it includes a storage memory for storing data coded at a given instant and relating to a complete scene description, the stored data being used at one or several later instants to form said access points.

3. A terminal as claimed in claim 2, characterized in that the access points are made in the data stream in timing with a replacement clock, and in that the data stream includes data relating to modifications to be applied to a complete scene which are introduced in the stream in timing with a modification clock which presents a non-zero phase shift relative to the replacement clock.

4. A terminal as claimed in claim 2, characterized in that the complete scene description for which coded data are stored in said memory is renewed in timing with a replacement clock.

5. A method of forming an access point in a data stream, said access points being formed by coded data relating to a complete scene description, characterized in that it includes a step of storing data coded at a given instant and relating to a complete scene description, the stored data being intended to be used at one or several later instants to form said access points.

6. A method as claimed in claim 5 of forming an access point in a data stream, characterized in that the access points are made in the data stream in timing with a replacement clock, and in that the data stream contains data relating to modifications to be made in a complete scene, which are made in the stream in timing with a modification clock which presents a non-zero phase shift relative to the replacement clock.

7. A method as claimed in claim 6 of forming an access point in a data stream, characterized in that the complete scene description for which data are stored is renewed in timing with a replacement clock.

8. A signal conveying a data stream which includes access points formed by coded data relating to a description of a complete scene, characterized in that at least various successive access points are formed by the same description of a complete scene.

9. A signal as claimed in claim 8, characterized in that the description of a complete scene, which is contained in the access points, changes in timing with a replacement clock.
